(19) United States
(12) Patent Application Publication
(10) Pub. No.: US 2009/0033631 A1
(43) Pub. Date: Feb. 5, 2009

(54) Rewritable Electronic Drawing Surface Using Bistable Media

(75) Inventors: Kin P. Tsui, Morton Grove, IL (US); Daniel R. Gamota, Palatine, IL (US); Krishna Kalyanasundaram, Elmhurst, IL (US); John B. Szczech, Schaumburg, IL (US); Jerzy Wieglus, Mt. Prospect, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/830,401

(22) Filed: Jul. 30, 2007

(51) Int. Cl. G06F 3/041

(52) U.S. Cl. 345/173

(57) ABSTRACT

An apparatus having an electronic drawing surface includes a common electrode overlying a least part of the outer surface of a housing, or other object, and a bistable media layer overlying the common electrode. The bistable media layer has at least two stable states and is operable to assume a first stable state in the region of a drawing tool when an electrical voltage difference is generated between the drawing tool and the common electrode. The voltage difference produces an electrical field across a region of the bistable media layer when the drawing tool is in close proximity to the bistable layer. Optionally, an outer surface of a plurality of transparent electrodes overlies the bistable media layer.

### FIELD OF THE INVENTION

The present invention relates generally to an electronic drawing surface. The electronic drawing surface may be used, for example, to provide a customizable housing for consumer electronic devices.

### BACKGROUND

Commercially available magnetic drawing surfaces are clean and easily erasable. However, they are bulky and cannot be easily integrated into flexible or conformable housings for electronic devices such as mobile telephones. A software-controllable active display can be made to have such a format, but it increases the size, cost and power consumption of the device.

An electrophoretic display is an information display that forms visible images by rearranging charged pigment particles using an applied electric field. In one example, positively charged white particles and negatively charged black particles are suspended in transparent liquid in a microcapsule. A film of microcapsules is placed between two electrodes: a front common transparent electrode and a rear pixel electrode. A transistor matrix in a backplane is used to apply volatges to the pixel electrodes. The direction of the electric field determines whether white or black particles are pulled to the front viewing surface, since the particles will migrate electrophoretically to the electrode bearing the charge opposite to that on the particles. The rear electrode is divided into a number of small picture elements (pixels), so that an image can be formed by applying the appropriate voltage to each region of the display to create a pattern of black and white regions.

Electrophoretic displays are examples of electronic paper, because of their paper-like appearance and low power consumption. However, an electrophoretic display with a rear electrode array cannot be used as a drawing surface without the use of a position sensing device and corresponding control circuitry to control the rear electrode array. Such components would increase the power consumption.

Other types of displays include cholesteric and nanochromatic displays and displays using liquid powders.

A portable device has been disclosed that has an outer surface of programmable electronic paper. The electronic paper changes appearance in response to data input from a keypad, thereby changing the appearance of the portable device. Keypad entry of data is not suitable for graphical input. In addition, the display requires a keypad and corresponding control circuitry. This makes the display unsuitable as an independent device that can be added to an existing portable device.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a cross sectional diagram of an electrophoretic display of the prior art.

FIG. 2 is a cross sectional diagram of a rewritable electronic drawing surface in accordance with some embodiments of the invention.

FIGS. 3 and 4 are simplified diagrams showing operation of a rewritable electronic drawing surface in accordance with some embodiments of the invention.

FIG. 5 is a flow chart of a method of drawing on a rewritable electronic drawing surface in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a rewritable electronic drawing surface. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

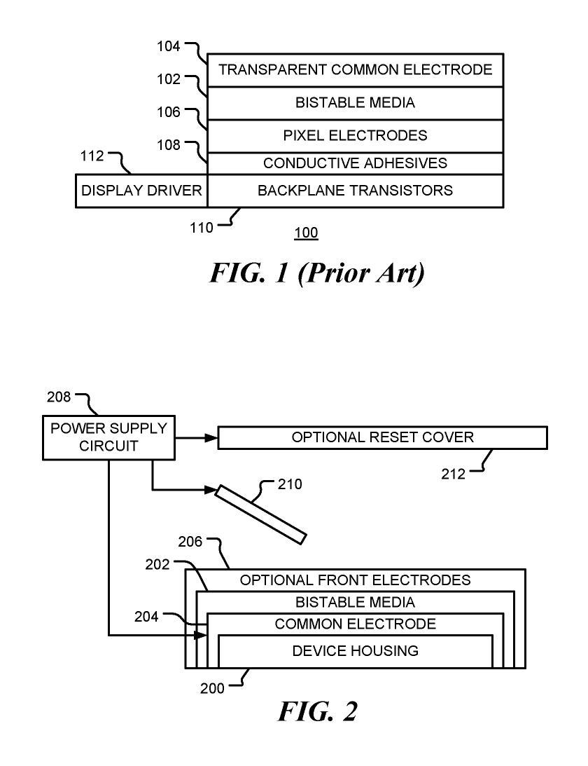

FIG. 1 is a cross sectional diagram of an electrophoretic display of the prior art. The display 100 uses bistable media 102 positioned between a front common electrode 104 and an array or matrix of rear electrodes 106. The term ‘bistable’ used herein is to be understood to include both media with exactly two stable states and also media with more than two stable states. The media has a different appearance, such as a different color, in each state. The state may be altered by an external influence, such as a static or oscillating electrical field, and the medium remains in the altered state once the influence is removed. Examples of bistable media include electrophorectic, cholesteric and nanochromic media as well as liquid powders and combinations thereof.

The rear electrodes are pixel electrodes that control which color is displayed at each picture element (pixel) of the display. The rear electrodes 106 are coupled by conductive adhesives 108 to backplane switching transistors 110. The transistors are commonly thin-film transistors (TFT's) arranged in an array to form an active-matrix. Each switching transistor corresponds to a pixel electrode and the array is controlled by a display driver 112. The front electrode 104 is a transparent electrode and is common to whole display.

The common electrode 104 and the pixel electrodes 106 are respectively driven at different electric potentials causing electric fields by which the charged pigment particles, in the bistable media layer 102, move in the desired directions to form a desired display content in response to display data.

To use such a display as an electronic drawing surface, the display driver must be provided with the display data. This, in turn, requires some kind of user input device. The display driver and transistors, and possibly the input device, would consume power and add cost and complexity to the device.

FIG. 2 is a cross sectional diagram of a rewritable electronic drawing surface in accordance with some embodiments of the invention. Referring to FIG. 2, the rewritable electronic drawing surface is shown overlying the housing of a device 200. The drawing surface may be the surface of the housing itself. The device 200 may be any object, such as a portable electronic device, a simple support structure. A bistable media layer 202, which may be flexible, overlies a rear common electrode 204. The bistable media layer 202 maybe, for example, a layer of encapsulated electrophoretic particles. Other bistable media may be used. In one embodiment, the bistable media layer 202 is deposited on the rear common electrode 204 using conventional vacuum, coating, or print processing technologies. In one embodiment, the rear common electrode 204 is a layer of conductive ink (such as carbon ink, ITO ink, or silver ink) that is printed or sprayed onto the device housing 200. The rear common electrode 204 may be connected to the entire drawable area. The device housing 200 may have any shape and may also be conformable.

Optionally, transparent front electrodes 206 may be used. These may be a conductive polymer, such as PEDOT, that is printed on top of the bistable media layer. The front electrodes provided enhanced electrical contact between a drawing tool (discussed below) and the bistable media layer. In addition, the front electrodes provide a protective layer that protects both the bistable media layer and any underlying product. Multiple front electrodes may be used to enhance the resolution of the drawing surface. In one embodiment, the electrodes are printed in an array.

In operation, a power circuit 208 is coupled to the rear common electrode 204 and also to a drawing tool 210. In one embodiment, the power circuit is integrated with the drawing tool. In a further embodiment, the power circuit is integrated with the underlying product. In a still further embodiment the power supply is a separate unit.

Optionally, a reset cover 212 is provided. In one embodiment, the reset cover includes a single common electrode 212 that may be connected to the power supply circuit 208 and used to reset the drawing surface.

In operation, an electrical potential is generated between the common rear electrode 204 and the drawing tool 210 (or the optional reset cover 212). Provided the field has sufficient strength, the area of the bistable media layer 202 is set according to the direction of the electrical field. In one embodiment, a user-operable switch is provided to enable control of the direction of the electric field generated by the power supply for data correction purposes.

One or more drawing tools 210 may be provided. The drawing tools may have different tip areas so as to allow a user to select the width of a line drawn with the drawing tool or the area of a stamp mark made by the tool. A drawing tool with a large tip area may be provided for use as an eraser.

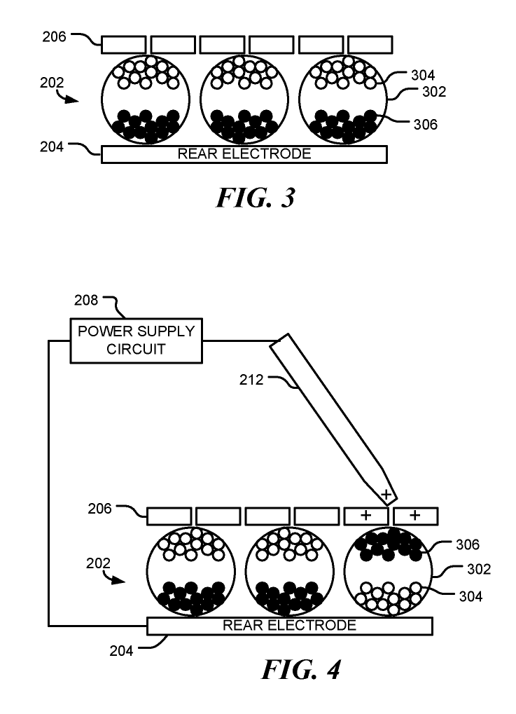

FIGS. 3 and 4 are simplified diagrams showing operation of a rewritable drawing surface in accordance with some embodiments of the invention. In the embodiment shown in FIGS. 3 and 4, the bistable media layer 202 comprises micro-encapsulated particles. A capsule 302 encloses positively charged white particles 304 and negatively charged black particles 306, all suspended in a liquid within the capsule 302. The bistable media layer 202 is positioned between a common rear electrode 204 and, optionally, a plurality of front electrodes 206. When no electrical field is applied, as shown in FIG. 3, each capsule 302 of the bistable media layer is stable in one of two stable configurations. In FIG. 4, one of the capsules is switched to a different stable configuration using the drawing tool 212. In FIG. 4, the drawing tool 212 is brought into close proximity to one or more of the front electrodes 206 and the power supply is used to generate an electric field across the bistable media in the region close to the drawing tool. In this example, the tip of the drawing tool 212 is held at a positive voltage relative to the rear electrode 204. The negatively charged black particles 306 are attracted to the drawing tool and displace the positively charged white particles 304. When the drawing tool is withdrawn, or the power supply is turned off, the charged particles remain in position, so that the region of the drawing surface appears black.

It will be apparent to those of ordinary skill in the art that other types of bistable media or electronic paper may be used without departing from the present invention. For example, charged particles may be suspended in a fluid that is contained in micro-cups in an embossed surface to form an electrophoretic, bistable media layer.

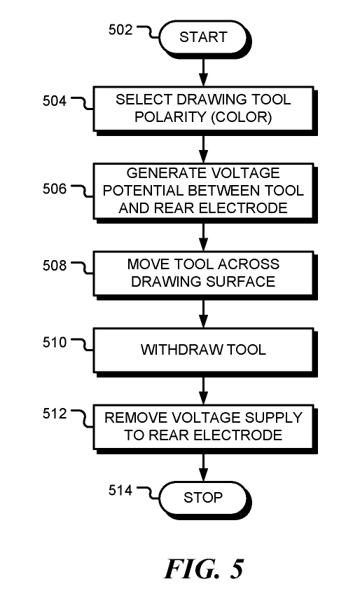

FIG. 5 is a flow chart of a method of drawing on a rewritable electronic drawing surface in accordance with some embodiments of the invention. Following start block 502 in FIG. 5, a user selects the polarity of the drawing tool at block 504. For example, a positive polarity may cause the drawing surface to appear black where the drawing tool contacts the surface and a negative polarity may cause the surface to appear white. Of course, the drawing surface may have other colors. At block 506, the power supply, which is coupled to the drawing tool and the rear common electrode, generates an electrical potential between the drawing tool and the rear common electrode. At block 508, the user brings the drawing tool into contact with the front drawing surface and moves the drawing tool across the drawing surface. This causes the drawing surface to take on the desired color in the region of the drawing tool. The optional front electrodes help to define the region over which the electrical potential is applied. At block 510 the user withdraws the drawing tool from the surface. At block 512, the voltage supply to the rear electrode is removed and the process terminates at block 514. In one embodiment, bringing the drawing tool into contact with the surface actives the power supply (using mechanical, electrical or optical switches for example), and withdrawing the drawing tools deactivates the power supply. The drawing tool maybe, for example, an electronic pen or an electronic stamp.

To reset the drawing surface, a reset cover comprising a common electrode may be placed over the drawing surface. The reset cover applies a common voltage across the drawing surface and causes the surface to become a single color.

The drawing surface may be applied to a variety of objects, including, for example, portable electronic devices, signs and toys. The drawing surface may have a variety of shapes.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

What is claimed is:

1. A rewritable electronic drawing surface comprising:
a common electrode;
a bistable media layer, in front of and overlying the common electrode, elements of the bistable media layer having at least two stable states;
a drawing tool; and
a power supply circuit operable to generate a first electrical voltage difference between the drawing tool and the common electrode;
wherein positioning the drawing tool close to an element of the bistable media layer forces the element into a first state of the at least two stable states.

2. A rewritable electronic drawing surface in accordance with claim 1, wherein the power supply circuit is further operable to generate a second electrical voltage difference between the drawing tool and the common electrode that forces an element of the bistable media layer into a second state of the at least two stable states when the drawing tool is positioned close to the bistable media layer.

3. A rewritable electronic drawing surface in accordance with claim 1, further comprising a reset cover, wherein the power supply circuit is further operable to generate a second electrical voltage difference between the reset cover and the common electrode.

4. A rewritable electronic drawing surface in accordance with claim 1, wherein the bistable media layer comprises electronic paper.

5. A rewritable electronic drawing surface in accordance with claim 1, wherein the common electrode comprises a conductive ink layer applied to the surface of a support structure.

6. A rewritable electronic drawing surface in accordance with claim 1, wherein the power supply is integrated with the drawing tool.

7. A rewritable electronic drawing surface in accordance with claim 1, wherein the drawing tool comprises an electronic pen.

8. A rewritable electronic drawing surface in accordance with claim 1, wherein the drawing tool comprises an electronic stamp.

9. A rewritable electronic drawing surface in accordance with claim 1, further comprising a plurality of transparent front electrodes, overlying the bistable media layer.

10. A rewritable electronic drawing surface in accordance with claim 9, wherein the plurality of transparent front electrodes comprise a conductive array.

11. A rewritable electronic drawing surface in accordance with claim 9, further comprising a switch operable to activate the power supply when the drawing tool is in contact with at least one of the plurality of transparent front electrodes.

12. A rewritable electronic drawing surface in accordance with claim 1, further comprising a switch operable to activate the power supply when the drawing tool is close to the bistable media layer.

13. A method for drawing on an electronic drawing surface comprising a bistable media layer overlying the front surface of a common electrode, the method comprising:
generating a voltage difference between a drawing tool and the common electrode, thereby producing an electrical field across a region of the bistable media layer when the drawing tool is in close proximity to the bistable layer.

14. A method in accordance with claim 13, wherein the drawing tool is in close proximity to the front of the bistable media layer when the drawing tool into contact with at least one of a plurality of electrodes overlying the bistable media layer.

15. A method in accordance with claim 14, further comprising:
detecting when the drawing tool is in contact with at least one of the plurality of electrodes overlying the bistable media layer; and
generating the voltage difference between a drawing tool and the common electrode when drawing tool is in contact with at least one of the plurality of electrodes overlying the bistable media layer.

16. An apparatus having an electronic drawing surface, the apparatus comprising:
a housing;
a common electrode overlying a least part of the outer surface of the housing;
a bistable media layer overlying the common electrode, the bistable media layer having at least two stable states and being operable to assume a first stable state of the at least two stable states in the region of a drawing tool when an electrical voltage difference is generated between the drawing tool and the common electrode.

17. An apparatus in accordance with claim 16, wherein the bistable media layer comprises a layer selected from the group of layers consisting of an electrophoretic layer, a cholesteric layer, a nanochromic layer and a liquid powder.

18. An apparatus in accordance with claim 16, further comprising a plurality of transparent electrodes overlying the bistable media layer.

19. An apparatus in accordance with claim 18, wherein the plurality of transparent front electrodes comprise a conductive array.

20. An apparatus in accordance with claim 18, further comprising a mobile electronic device housed within the housing.

21. A rewritable electronic drawing surface comprising:
a common electrode;
a bistable media layer, overlying the common electrode, elements of the bistable media layer having at least two stable states; and
a plurality of transparent front electrodes overlying the bistable media layer.
wherein application of an electrical voltage difference between the common electrode and a transparent front electrode of the plurality of transparent front electrodes forces an element of the bistable media layer into a first state of the at least two stable states.

22. A rewritable electronic drawing surface in accordance with claim 21 comprising:
a drawing tool; and
a power supply circuit operable to generate an electrical voltage difference between the drawing tool and the common electrode;
wherein positioning the drawing tool close to a transparent front electrode of the plurality of transparent front electrodes of the bistable media layer forces an element of the bistable media layer into a first state of the at least two stable states.

23. A rewritable electronic drawing surface in accordance with claim 21 wherein the bistable media layer comprises electronic paper.
